(19) United States
(12) Patent Application Publication
(10) Pub. No.: US 2017/0363261 A1
(43) Pub. Date: Dec. 21, 2017

(54) RECESSED DOWNLIGHT WITH INTEGRAL JUNCTION BOX

(71) Applicant: City Electric Supply Co., Dallas, TX (US)

(72) Inventor: Keelan Harlow White, Markham (ONT) (CA)

(21) Appl. No.: 15/186,815

(22) Filed: Jun. 20, 2016

(51) Int. Cl. F21S 8/02; F21V 23/06; F21V 23/00; F21V 17/10; F21V 7/22; F21V 3/02; F21V 8/00; F21V 21/04; F21Y 2115/10

(52) U.S. Cl. CPC F21S 8/026; G02B 6/0001; F21V 23/06; F21V 23/005; F21V 21/04; F21V 17/107; F21V 7/22; F21V 3/02; F21Y 2115/10

(57) ABSTRACT

A recessed downlight integrates a light engine assembly with a junction box containing a driver assembly. A single torsion spring is supplied at an end of the light engine assembly remote from its connection to the junction box, while a leaf spring attaches to the junction box near its connection to the light engine assembly, or is alternatively integrated into an extension of the junction box. The leaf spring allows for a high-enough tension to hold the light unit assembly in place in thin sheet metal, while allowing for a low-enough tension to accommodate holding the light unit assembly in place in drywall or a drop ceiling.

### FIELD OF THE INVENTION

The invention relates to a recessed downlight that integrates a light engine assembly with a junction box containing the driver assembly.

### BACKGROUND OF THE INVENTION

Recessed, flush-mounted downlights are suitable for mounting in soffits, above drywall, or above a dropped ceiling. These luminaires include a housing, trim, and a lamp. Various types of lamp are known, including incandescent, high-intensity discharge, compact fluorescent, and light emitting diodes (LEDs).

Some of these lamps do not operate at traditional line voltages, but rather require transformers, ballasts, or other electronics. These other components are frequently mounted in an isolated but connected junction box.

The light engine assembly and driver assembly are typically mounted separately, with the components connected electrically. This electrical connection can be cable routed through the air or a cable routed through flexible conduit. However, such an installation is governed by applicable safety codes, which for example require consideration of the presence or absence of flammable materials, such as insulation.

To better facilitate installation and to meet safety codes, there is a requirement for an improved recessed luminaire based that mechanically connects the light engine assembly with the junction box containing the driver assembly, minimizing the external wiring between these components and enhancing code compliance.

### SUMMARY OF THE INVENTION

The present invention provides a recessed luminaire that integrates the light engine assembly with the junction box containing the driver assembly. This facilitates installation of the luminaire, while meeting the strict safety codes required in certain jurisdictions, such as Underwriters Laboratories 1598, “Standard for Safety for Luminaires” (Third Edition, Sep. 1, 2008).

One challenge of developing an integrated luminare is to develop a mounting configuration that is flexible enough to accommodate a range of installations from very thin 28 gauge sheet metal soffits to ⅝″ thick drywall or a drop ceiling. The solution of the present invention is, in one embodiment, a single torsion spring at an end of the light engine assembly remote from its connection to the junction box, while a leaf spring attaches to the junction box near its connection to the light engine assembly. In a second embodiment, the leaf spring is integrated into an extension of the junction box. The leaf spring allows for a high-enough tension to hold the light unit assembly in place in thin sheet metal, while allowing for a low-enough tension to accommodate holding the light unit assembly in place in drywall or a drop ceiling.

The luminaire configured and arranged as described can be constructed using any known combination of materials.

### BRIEF DESCRIPTION OF THE DRAWINGS

Preferred embodiments of the invention are described herein below with reference to the drawings wherein:

FIG. 1 illustrates a luminaire designed for recessed installation;

FIG. 2 is another view of the luminaire designed for recessed installation;

FIG. 3 is an exploded view of the light engine assembly and a partially exploded view of the driver assembly;

FIG. 4 is an exploded view of the driver assembly; and

FIG. 5 is a plan view of the luminaire.

### DETAILED DESCRIPTION OF THE INVENTION

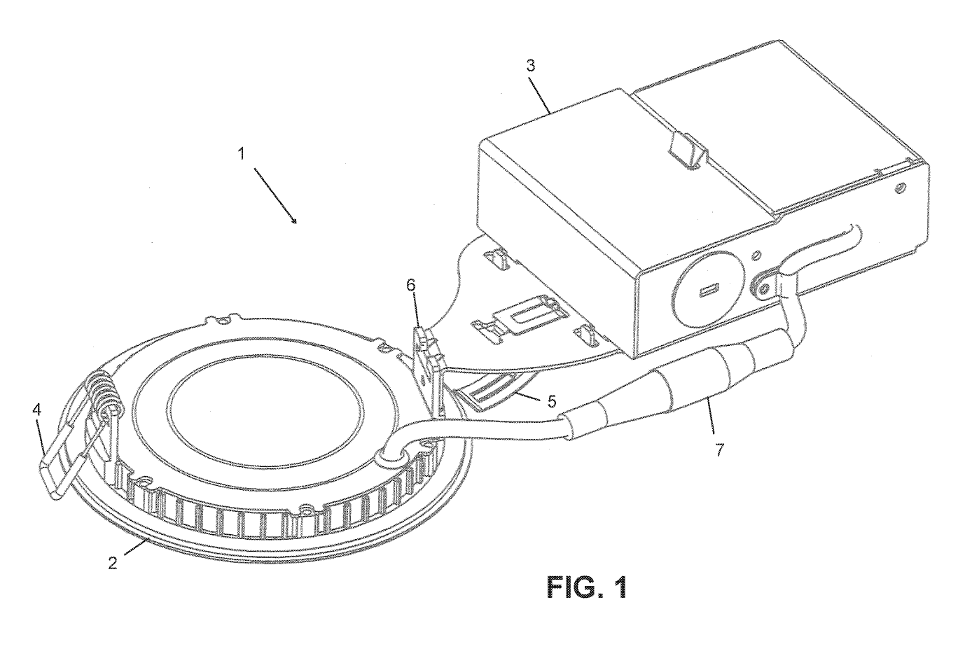

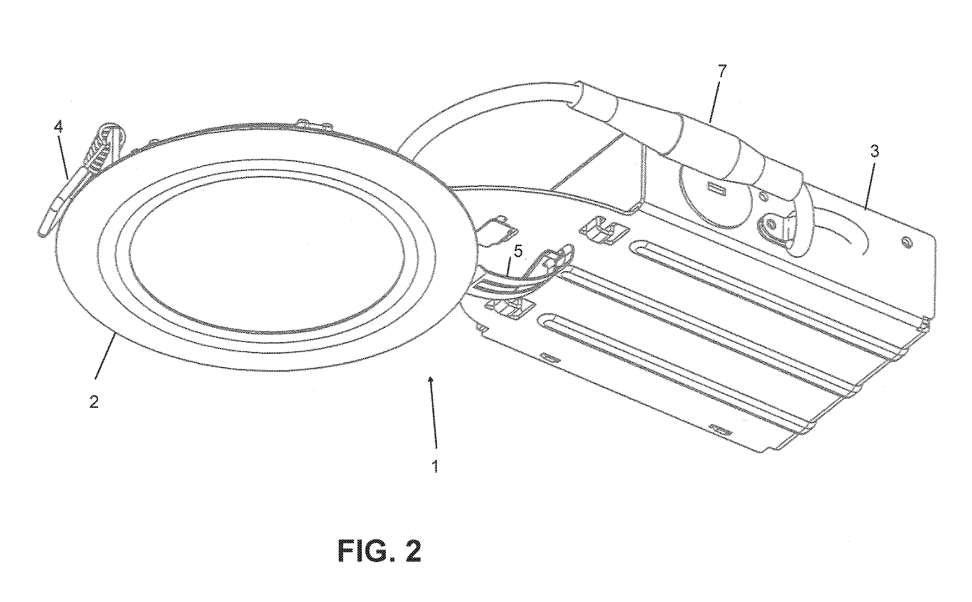

Referring now to FIGS. 1 and 2, there is illustrated a preferred embodiment of the present invention in which the luminaire 1 includes a light engine assembly 2 and a driver assembly 3. Light engine assembly 2 and driver assembly 3 are mechanically connected through mechanical connector 6. As is known in the art, mechanical connector 6 can be a permanent connector, such as a weld, or can be a removable connector, such as a connection made by screw, nut and bolt, and so forth. For ease of shipping, it is especially advantageous for mechanical connector 6 to be a removable connector. In one embodiment, a hinge is incorporated into mechanical connector 6 to provide for rotational flexibility in the mechanical connection between light engine assembly 2 and driver assembly 3.

Light engine assembly 2 and driver assembly 3 are electrically connected through electrical connector 7. As is known in the art, electrical connector 7 can be a single cable that at a first end terminates at light engine assembly 2 and at a second end terminates at driver assembly 3, with the terminations made via a terminal block, or a plug-in connector, or a twist-lock pin and sleeve connector, or via other connectors known in the art. Alternatively, electrical connector 7 can be two cables and a two-part connector, such that the first cable terminates at a first end at light engine assembly 2 and at a second end terminates at a first part of the two-part connector, with the second cable that terminates at a first end at driver assembly 3 and at a second end terminates at the second part of the two-part connector.

A single torsion spring 4 is installed in light engine assembly 2 at a far end from the mechanical connector 6 joining light engine assembly 2 to the junction box of driver assembly 3. Driver assembly 3 incorporates a leaf spring 5 that attaches to the junction box of the driver assembly 3, or else that is integrated into an extension of the junction box, with leaf spring 5 being positioned in close proximity to mechanical connector 6. As discussed above, the leaf spring allows for a high-enough tension to hold the light unit assembly in place in thin sheet metal, while allowing for a low-enough tension to accommodate holding the light unit assembly in place in drywall or a drop ceiling.

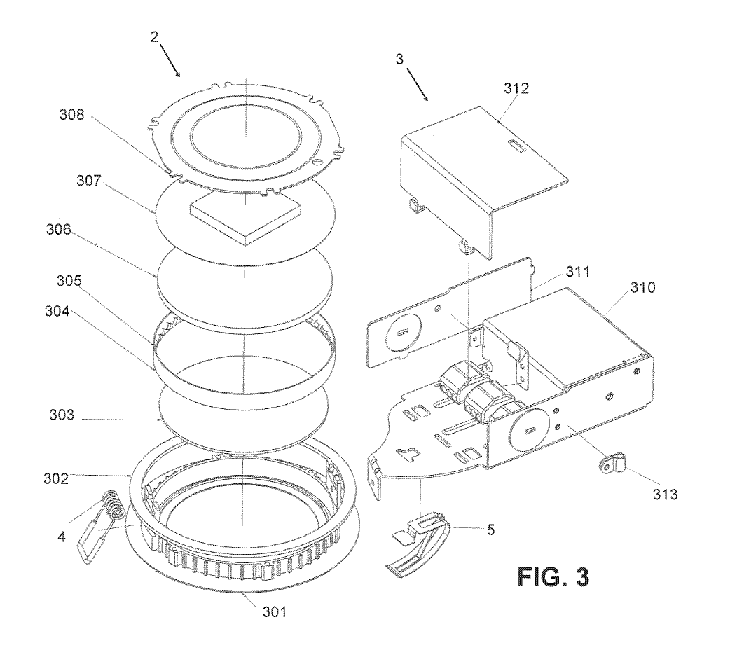

FIG. 3 illustrates one embodiment of the invention showing exploded views of light engine assembly 2.

Light engine assembly 2 includes a trim piece 301 and foam gasket 302, which will contact the material against which luminaire 1 is installed, such as a sheet metal soffit, drywall, or a drop ceiling. Torsion spring 4 attaches to trim piece 301.

Mounted inside trim piece 301 is an optical diffuser 303, and printed circuit board assembly (PCBA) 305, on which are installed light emitting diodes, is installed within trim piece 301 and held in place with thermal adhesive 304. Light guide 306 and reflective film 307 are also installed within trim piece 301. The aforementioned components within trim piece 301 are secured in place by rear cover plate 308, which is attached to trim piece 301, such as with screws or bolts.

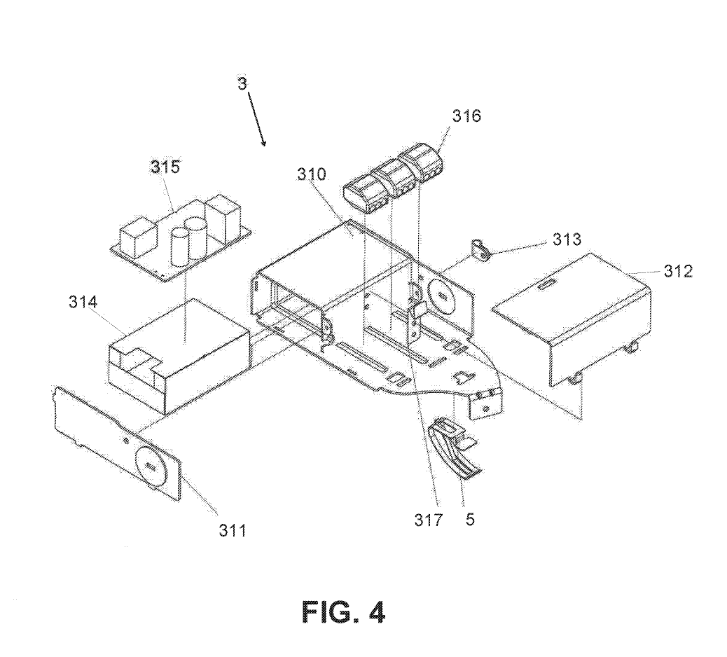

FIG. 3 also shows an exploded view of driver assembly 3, for which additional details are shown in FIG. 4. In the embodiment shown, mounting cover 310 forms the largest component of the junction box housing the driver assembly 3. Wiring cover 312 is removable, providing access to terminal blocks 316, which are provided for termination of electrical supply conductors. Wiring cover 312 is secured in a closed position with lock spring 317. A removable side plate 311 allows access to the driver electronics 315, for which insulation paper 314 is supplied. Wiring clip 313 is provided for securing electrical connector 7 to the exterior of mounting cover 310.

Leaf spring 5 attaches to mounting cover 310 in the embodiment shown. As discussed previously, in another embodiment it is integrated into an extension of the junction box.

In a preferred embodiment, mechanical connector 6 provides for a vertical offset between light engine assembly 2 and driver assembly 3, such that the bottom of driver assembly 3 is at a horizontal plane that is higher than the horizontal plane of the bottom of light engine assembly 2. For example, this allows trim piece 301 at the bottom of light engine assembly 2 to be mounted within a drywall ceiling, with the vertical offset allowing the bottom of driver assembly 3 to be positioned within the ceiling cavity and allow for mounting into material thicknesses ranging from 28 gauge sheet metal through ⅝″ drywall. Or alternatively, trim piece 301 can be mounted within a drop ceiling, with the vertical offset allowing the bottom of driver assembly 3 to clear the top of the runners and cross-ties supporting the drop ceiling.

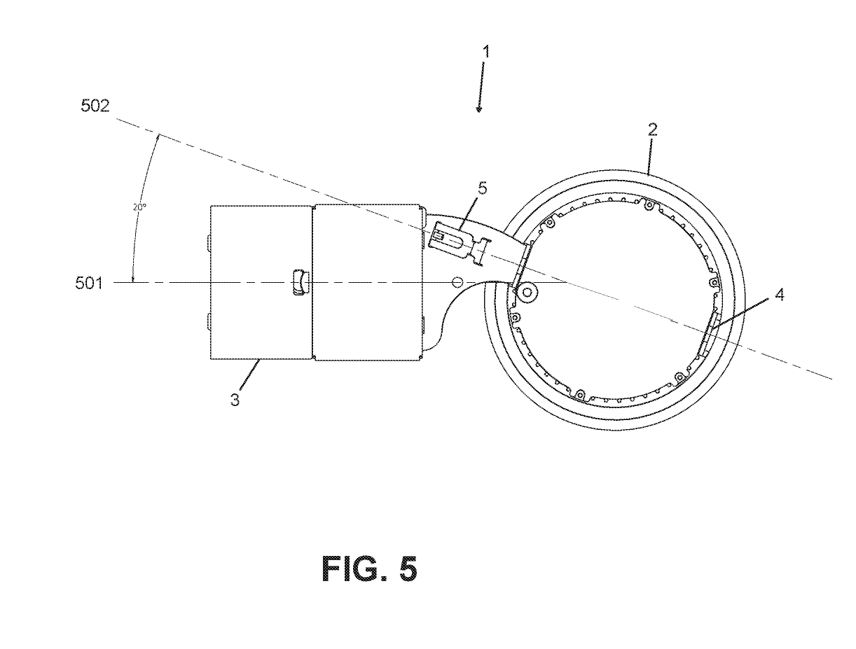

FIG. 5 illustrates another preferred embodiment, in which a centerline 501 of the driver assembly 3 intersecting the light engine assembly 2 is placed at an angle, preferably greater than 10°, to a centerline 502 of the light engine assembly 2 that passes through torsion spring 4 and leaf spring 5. This allows for greater flexibility in mounting luminaire 1 in a ceiling such that light engine assembly 2 is positioned in the desired location while allowing driver assembly 3 to avoid a joist or other obstruction that may be present within the ceiling cavity.

While preferred embodiments of the present invention have been illustrated and described herein, it will be apparent that such embodiments are provided by way of example only. Numerous variations, changes and substitutions will be apparent to those skilled in the art without departing from the invention, the scope of which is to be determined by the following claims.

I claim:

1. A recessed downlight comprising:
a light engine assembly; and
a driver assembly that is mechanically connected to the light engine assembly;
wherein a torsion spring is supplied at an end of the light engine assembly at a farthest point from its mechanical connection to the driver assembly; and
wherein a leaf spring is supplied at the driver assembly adjacent to its mechanical connection to the light engine assembly.

2. The recessed downlight of claim 1, wherein the leaf spring is removable from the driver assembly.

3. The recessed downlight of claim 1, wherein the leaf spring is an integral part of the driver assembly.

4. The recessed downlight of claim 1, wherein an electrical connector is provided between the light engine assembly and the driver assembly.

5. The recessed downlight of claim 1, wherein the leaf spring allows for a high-enough tension to hold the light unit assembly in place in thin sheet metal, while allowing for a low-enough tension to accommodate holding the light unit assembly in place in drywall or a drop ceiling.

6. The recessed downlight of claim 1, wherein a horizontal centerline of the driver assembly intersects the light engine assembly at an angular offset from a horizontal centerline of the light engine assembly that passes through the torsion spring and the leaf spring.

7. The recessed downlight of claim 1, wherein the mechanical connection between the driver assembly and the light engine assembly includes a hinge that allows for a rotation between the driver assembly and the light engine assembly.

8. A recessed downlight comprising:
a light engine assembly; and
a driver assembly that is mechanically connected to the light engine assembly;
wherein the light engine assembly comprises a circular base on a first horizontal plane, the circular base configured to be mounted in a soffit, above drywall, or above a dropped ceiling;
wherein the driver assembly comprises an enclosure with a bottom portion comprising a second horizontal plane; and
wherein the mechanical connection between the light engine assembly and the driver assembly comprises a vertical offset such that when the light engine assembly is mounted, the second horizontal plane is at a higher elevation than the first horizontal plane.

9. The recessed downlight of claim 8, wherein an electrical connector is provided between the light engine assembly and the driver assembly.

10. The recessed downlight of claim 8, wherein the mechanical connection between the driver assembly and the light engine assembly includes a hinge that allows for a rotation between the driver assembly and the light engine assembly.

11. The recessed downlight of claim 8, wherein a torsion spring is supplied at an end of the light engine assembly at a farthest point from its mechanical connection to the driver assembly;
and wherein a leaf spring is supplied at the driver assembly adjacent to its mechanical connection to the light engine assembly.

12. The recessed downlight of claim 11, wherein a horizontal centerline of the driver assembly intersects the light engine assembly at an angular offset from a horizontal centerline of the light engine assembly that passes through the torsion spring and the leaf spring.
